(19) United States
(12) Patent Application Publication
(10) Pub. No.: US 2019/0305377 A1
(43) Pub. Date: Oct. 3, 2019

(54) FOLDED BATTERY CELL STRUCTURE FOR APPLICATION OF STACK PRESSURE

(71) Applicant: Intel Corporation, Santa Clara, CA (US)

(72) Inventor: Andrew W. Keates, Los Gatos, CA (US)

(73) Assignee: Intel Corporation, Santa Clara, CA (US)

(21) Appl. No.: 15/939,574

(22) Filed: Mar. 29, 2018

(51) Int. Cl. H01M 10/0583; H01M 10/0525; H01M 2/02

(52) U.S. Cl. CPC H01M 10/0583; H01M 2/02; H01M 10/0525

(57) ABSTRACT

An improved method of making a battery uses a sheet of one material for the anode, a sheet of a second material for the cathode, and a sheet of separator material between them to form a laminate of the three sheets. To make this laminate into a form factor suitable for a small thin battery, the anode sheet and cathode sheet may have slots to enable each sheet to be easily folded along the slot lines to create a concertina configuration.

### TECHNICAL FIELD OF THE INVENTION

Various embodiments of the invention relate to the internal structure of a battery and methods of making same.

### BACKGROUND

Lithium-metal battery cells typically use a layer of lithium metal deposited on metal foil current collector for the anode, a metal oxide deposited on a sheet of different metal for the cathode, and a sheet of separator material between them to form a sandwich assembly configuration. To work effectively and reliably, uniform pressure should be applied across the lithium and metal sheets so that uniform contact is made between adjacent layers of this assembly and between lithium particles deposited at the anode. In cylindrical batteries, the layered assembly may be rolled up and the roll positioned in a cylindrical case, which applies inward pressure on the rolled layers. However, cylindrical batteries are generally too big to be practical in a thin form-factor mobile device such as smart phones. Stacked batteries may be better for this application, since the layers may be placed parallel to the largest surface of a thin rectangular battery, and ‘squeezed’ between those two largest surfaces. However, this structure makes it difficult to apply uniform pressure across the layers since that surface is only attached at the edges and may flex in the middle of that surface. Also, in the event of an internal short between the anode and cathode, the large area of each sheet allows sufficient current flow to overheat the battery and possibly cause a fire.

An improved version of this concept may make the surfaces the same size as, and parallel to, one of the smaller sides of the rectangular battery. These surfaces have less distance between their attachment edges and therefore will flex less, resulting in more uniform pressure. However, a disadvantage of this approach is that it requires a large number of electrodes (anodes and cathodes) to be accurately aligned and electrically connected with welds, which increases the cost of manufacturing and increases the chance of manufacturing errors that may result in an unreliable battery.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a first sheet of material to be used as a battery electrode, with individual parallel slots formed in the sheet.

FIG. 2A shows a slotted anode sheet, an unslotted separator sheet, and a slotted cathode sheet pressed together into a laminate.

FIG. 2B shows a series of fold lines on the laminate of FIG. 2A.

FIG. 3 shows a laminate folded along the fold lines of FIG. 2B.

FIGS. 4A and 4B show edge views of the folded laminate of FIG. 3B with each fold being 180 degrees.

FIGS. 5A and 5B show other possible configurations slots in the sheets of the laminate.

FIG. 6 shows a flow diagram of an alternate method of forming the slots of FIGS. 2A, 5A, and 5B.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented fully or partially in software and/or firmware. This software and/or firmware may take the form of instructions contained in or on a non-transitory computer-readable storage medium. The instructions may be read and executed by one or more processors to enable performance of the operations described herein. The medium may be internal or external to the device containing the processor(s), and may be internal or external to the device performing the operations. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

As used in this document, the term ‘concertina configuration’ refers to a configuration of parallel, alternating, evenly-spaced individual folds in a sheet, or in multiple sheets pressed against each other. Any reference to an electrode may indicate either an anode or a cathode, or the material that is intended to act as either in the final battery assembly.

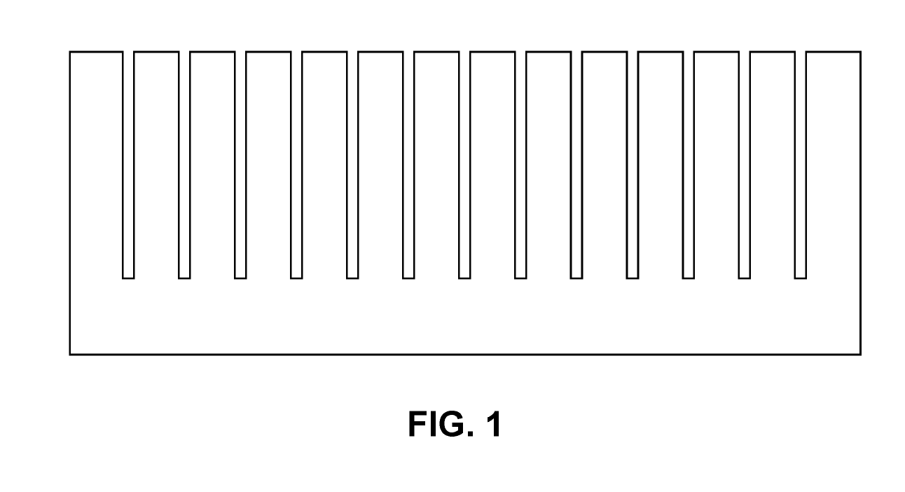

According to an embodiment of the invention, FIG. 1 shows a first sheet of material to be used as a battery electrode, with individual parallel slots formed in the sheet. In the illustrated embodiment, the slots are open at one end and closed at the other end. Within this document, the material between slots may be referred to as ‘fingers’, while the portion of the sheet without slots may be referred to as the ‘base’. In some embodiments, each slot has the same width. In some embodiments, each finger has the same width. The electrode of FIG. 1 may be either an anode or a cathode, and in fact some embodiments may use the same size and shape for both the anode and cathode sheets.

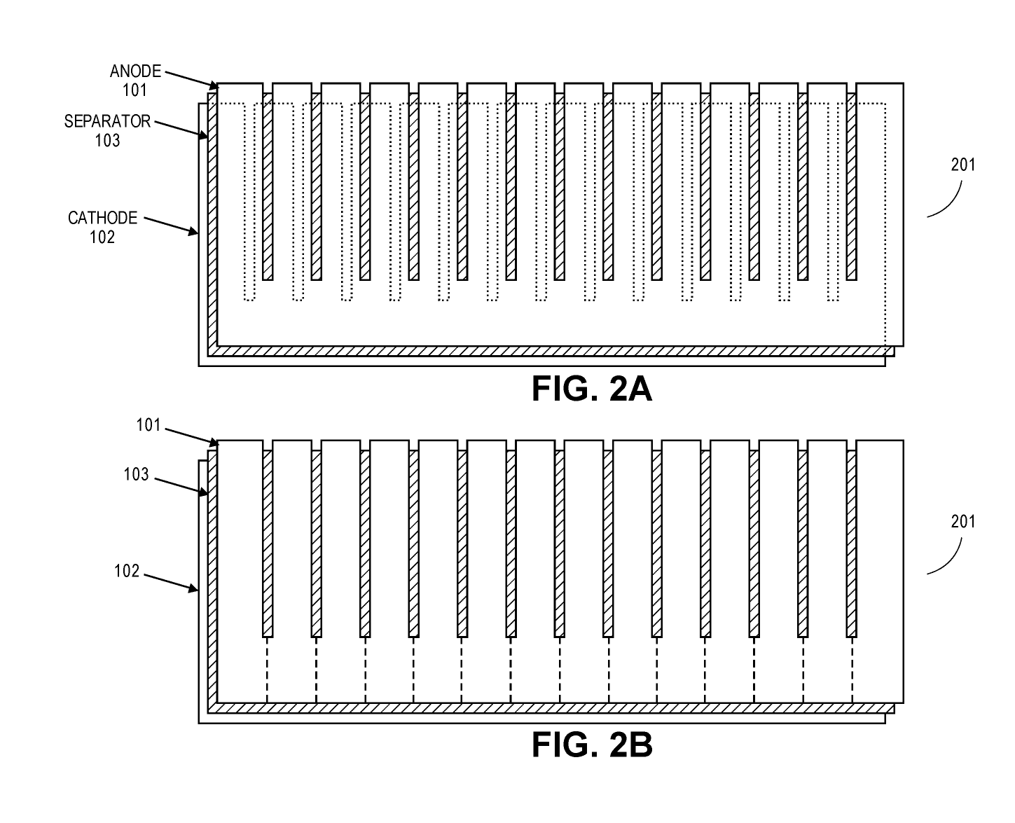

According to an embodiment of the invention, FIG. 2A shows an anode sheet 101 and cathode sheet 102 with a separator sheet 103 between them. The separator sheet may be unslotted. The dotted lines of FIG. 2A indicate that the cathode sheet 102 may have the same slots as the anode sheet 101. In some embodiments, the separator sheet may have the same length and width as the anode and cathode sheets. In some embodiments, the separator sheet may have slightly different length and/or width as the anode and cathode sheets. For example, the separator sheet may be slightly larger to prevent manufacturing tolerances or operations from causing a short circuit between the anode and cathode at their edges.

The anode sheet, separator sheet, and cathode sheet may be pressed together into a laminate 201 with the fingers of the anode sheet aligned with the fingers of the cathode sheet. As used in this document, the term ‘laminate’ indicates multiple sheets of material in physical surface contact with each other. Even though FIG. 2A and other Figs make it appear that there might be some slight separation between sheets, this is done just to more clearly show that there are multiple sheets.

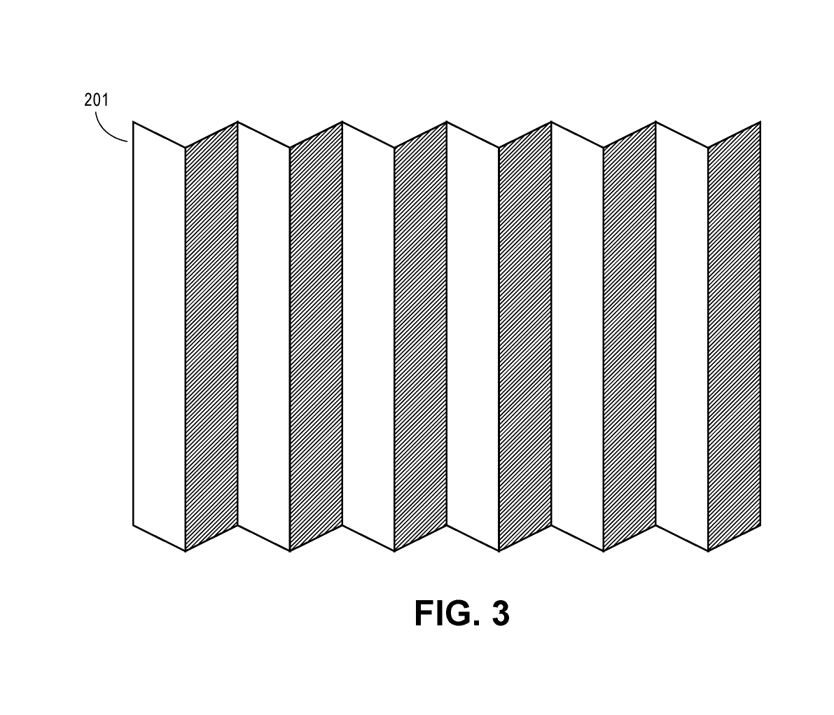

The perspective of FIG. 2A implies that the open end of the fingers for both the anode sheet and cathode sheet are at the same end of the laminate (e.g., the ‘top’ of FIG. 2A). As described later, other embodiments may have the open end of the fingers of the cathode at the opposite end of the laminate (e.g., the ‘bottom’ of FIG. 2A) from the anode. According to an embodiment of the invention, FIG. 2B shows a series of fold lines, each fold line indicated by a dashed line, each dashed line aligned with a corresponding slot. The fold lines are shown for conceptual purposes, and do not necessarily represent a physical line drawn, etched or otherwise marked on the material. FIG. 3 shows laminate 201 folded into a concertina configuration along the fold lines. As shown, each consecutive fold is bent in the opposite direction from the preceding fold, resulting in the ‘concertina’ configuration defined earlier in this document.

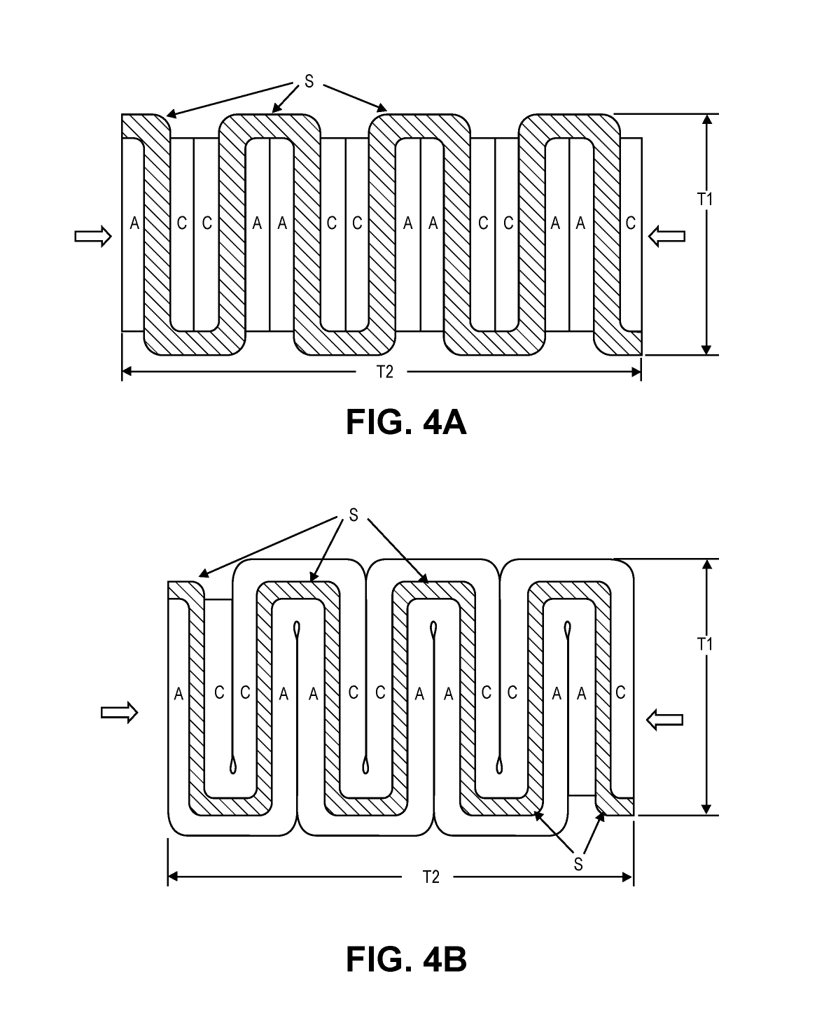

According to an embodiment of the invention, FIGS. 4A and 4B show a view of the concertina configuration of FIG. 3, with each fold completed into a 180 degree fold. The perspective of FIG. 4A is an edge view from the tip of the fingers. ‘S’ indicates the edge of the separator sheet, ‘A’ indicates the edge of the anode sheet, and ‘C’ indicates the edge of the cathode sheet. To enable the concertina configuration to be plainly seen, the proportions and quantities may not be accurate in the drawings. As can be seen, some pairs of adjacent fingers of the anode may be flush against each other, effectively resulting in anode fingers of double the thickness of the anode sheet. Similarly, some adjacent fingers of the cathode may be flush against each other, effectively resulting in cathode fingers of double the thickness of the cathode sheet.

As can also be seen, the separator wraps around the edge of each double thickness anode finger and each double thickness cathode finger. This may prevent a short circuit if an anode finger and a cathode finger are mis-aligned with each other. FIG. 4B shows a similar view of the base end of the laminate. FIG. 4B is much the same as FIG. 4A, except that the anode and cathode sheets may each be continuous due to the absence of fingers at that end.

In the final battery assembly, the outer fingers may be squeezed toward the middle of the assembly (in the direction of the arrows indicated in FIG. 4A), thus assuring that every anode finger and every cathode finger is fully pressed against the separator for full efficiency. In some embodiments, opposing sides of the battery case may provide this squeezing pressure. Similarly, the outer, exposed surfaces of the base may be squeezed toward the middle of the assembly (in the direction of the arrows indicated in FIG. 4B, thus assuring contact with the separator. The dimension T2 in both Figures may represent the inner dimensions of the battery case in that direction. Similarly, the dimension T1 in both Figures may represent the inner dimension of the battery case in the indicated direction.

The finger and base configuration of the anode and cathode may have several advantages. For example, the narrowness of each finger may act as a current-limiting shape, thereby preventing a defect in the battery from creating an over-current in that finger and thus creating a dangerous over-temperature condition in that finger. As a further current limit, each finger may be notched next to the base (not shown) to restrict current flow even more between the finger and base.

The slots between fingers may make it easier to perform the folding operation during manufacture of the battery. The much wider base portion of each electrode may be sufficient for the cumulative current from all that electrode's fingers. If opposite edges of the concertina configuration expose the anode at one end and the cathode at the other end, those exposed surfaces of the base may provide a handy area for electrical connections of the anode and cathode.

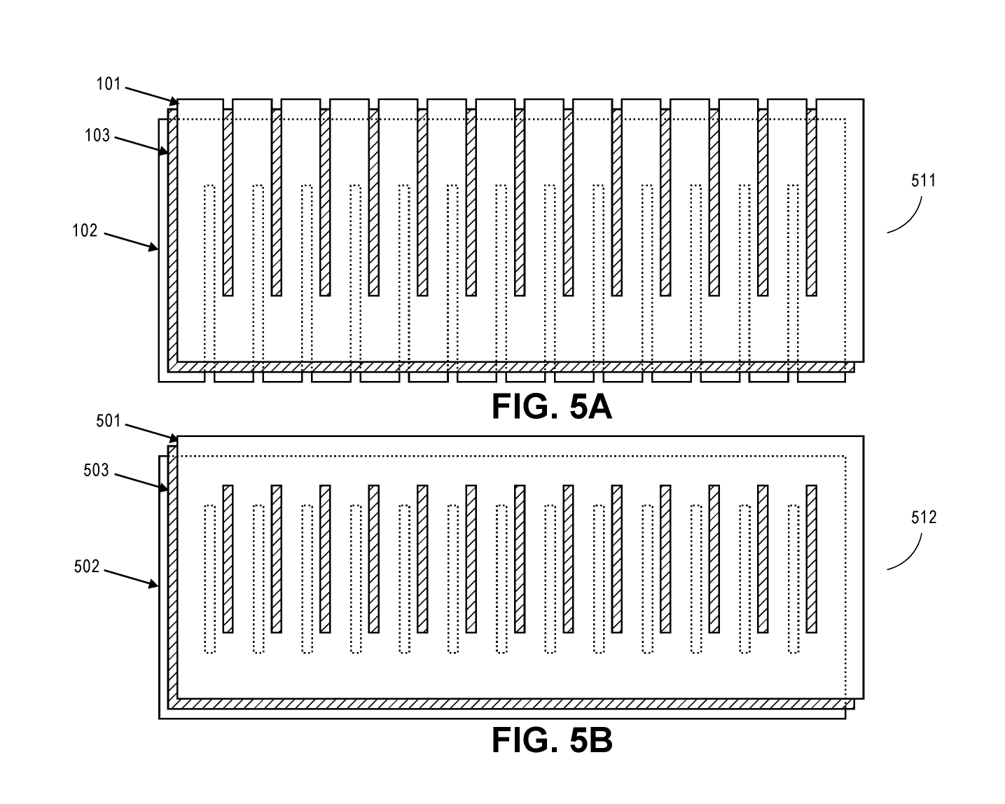

Although the previously described anode and cathode have slots that are open at the same end and the bases of the anode and cathode are at the same end in the final assembly, other embodiments are possible. For example, the base of the anode may be at the same end as the open fingers of the cathode, and the base of the cathode may be at the same end as the open fingers of the anode, as indicated in FIG. 5A. In another embodiment, one or both of the anode and cathode may have slots that do not extend to either end of the sheet, thus creating two bases in each sheet, as indicated in FIG. 5B. As with FIG. 2A, the dotted lines may indicate the outlines of the cathode 102.

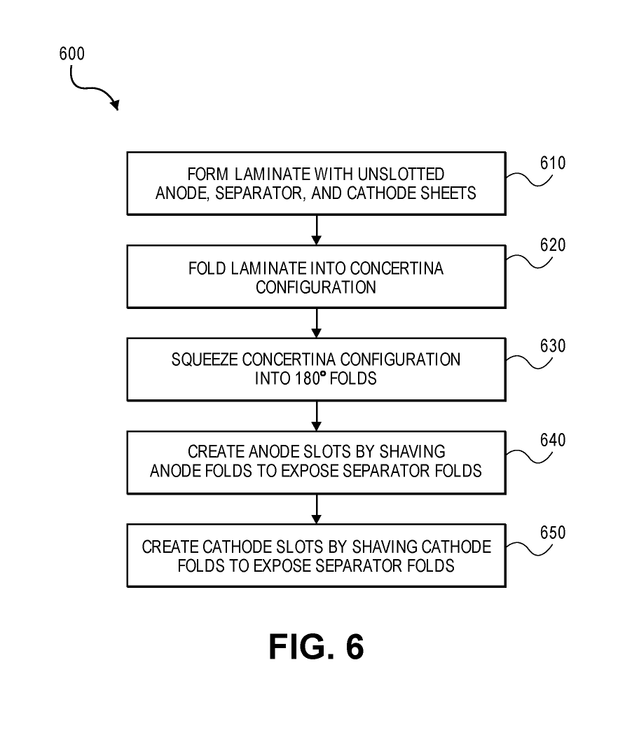

FIG. 6 shows a flow diagram of an alternate method of forming the previously described elements of a battery, according to an embodiment of the invention. In flow diagram 600, at 610 a laminate may be formed with a separator sheet between an anode sheet and a cathode sheet. But in this method, the anode and cathode sheets may be unslotted when the laminate is formed. At 620, this laminate may be folded into a concertina configuration, much as it was in FIG. 3. As in FIG. 2B, there may be fold lines to indicate where the alternating folds take place.

At FIG. 630, the concertina configuration may be squeezed into 180 degree folds, which may produce edge views at both ends similar to that shown in FIG. 4B. Electrically, this configuration may be used as the core of a battery, but without the advantages inherent in the embodiments described earlier that have slots.

At 640, slots may be created in the anode sheet by removing the exposed folds in the anode sheet (i.e., the exposed anode folds at the bottom of FIG. 4B). This removal should be deep enough to expose the underlying separator sheet. Various techniques may be used for this removal, such as but not limited to shaving, etching, etc. At 650, slots may be created in the cathode sheet by removing the exposed folds in the cathode sheet (i.e., the exposed cathode folds at the top of FIG. 4B). As with the anode, this removal may be accomplished in various ways.

The slots resulting from operations 640 and 650 may have various lengths and may or may not reach the edge. For example, these slots may result in the embodiments shown in FIG. 2A, 5A, or 5B. Other slot configurations, not shown, may also be achieved.

### Examples

The following examples pertain to particular embodiments

Example 1 includes a method of making a battery, comprising: providing a first sheet of material for a battery anode, the first sheet having a first series of parallel evenly spaced slots; providing a second sheet of material for a battery cathode, the second sheet having a second series of parallel evenly spaced slots matching the first series of slots; placing a separator sheet between the first sheet and the second sheet to form a laminate, the slots of the first sheet aligned with the slots of the second sheet; and folding the laminate along multiple parallel folds, each fold aligned with a corresponding slot; wherein alternating folds are folded in opposite directions to form a concertina configuration.

Example 2 includes the method of example 1, wherein each fold is a fold of approximately 180 degrees.

Example 3 includes the method of example 1, wherein the first sheet of material contains lithium ions.

Example 4 includes the method of example 1, wherein the material between each pair of adjacent slots is considered a finger; and the method further comprises applying pressure from opposing sides of the concertina configuration to maintain contact between each finger and the separator sheet:

Example 5 includes the method of example 1, wherein the slots extend to one edge of the first sheet but not to an opposing edge of the first sheet.

Example 6 includes the method of example 1, wherein the slots do not extend to any edge of the first sheet.

Example 7 includes the method of example 1, further comprising placing the concertina configuration in a battery case.

Example 8 includes a computer-readable non-transitory storage medium that contains instructions, which when executed by one or more processors result in performing operations comprising: providing a first sheet of material for a battery anode, the first sheet having a first series of parallel evenly spaced slots; providing a second sheet of material for a battery cathode, the second sheet having a second series of parallel evenly spaced slots matching the first series of slots; placing a separator sheet between the first sheet and the second sheet to form a laminate, the slots of the first sheet aligned with the slots of the second sheet; and folding the laminate along multiple parallel folds, each fold aligned with a corresponding slot; wherein alternating folds are folded in opposite directions to form a concertina configuration.

Example 9 includes the medium of example 8, wherein each fold is a fold of approximately 180 degrees.

Example 10 includes the medium of example 8, wherein the first sheet of material contains lithium ions.

Example 11 includes the medium of example 8, wherein the material between each pair of adjacent slots is considered a finger; and the method further comprises applying pressure from opposing sides of the concertina configuration to maintain contact between each finger and the separator sheet:

Example 12 includes the medium of example 8, wherein the slots extend to one edge of the first sheet but not to an opposing edge of the first sheet.

Example 13 includes the medium of example 8, wherein the slots do not extend to any edge of the first sheet.

Example 14 includes the medium of example 8, wherein the operations further comprise placing the concertina configuration in a battery case.

Example 15 includes a battery assembly, comprising: a laminate having an anode sheet with parallel evenly spaced slots, a cathode sheet with parallel evenly spaced slots, and an unslotted separator sheet between the anode sheet and the cathode sheet; wherein the laminate is folded into a concertina configuration with 180 degree folds aligned with the slots.

Example 16 includes the battery assembly of example 15, wherein the anode sheet contains lithium ions.

Example 17 includes the battery assembly of example 15, wherein the slots of the anode sheet and the slots of the cathode sheet are open at a same end of the laminate.

Example 18 includes the battery assembly of example 15, wherein the slots of the anode sheet and the slots of the cathode sheet are open at opposite edges of the laminate.

Example 19 includes the battery assembly of example 15, wherein the slots of the anode are not open at any edge of the anode sheet.

Example 20 includes the battery assembly of example 15, further comprising a battery case containing the concertina configuration.

The foregoing description is intended to be illustrative and not limiting. Variations will occur to those of skill in the art. Those variations are intended to be included in the various embodiments of the invention, which are limited only by the scope of the following claims.

What is claimed is:

1. A method of making a battery, comprising:
providing a first sheet of material for a battery anode, the first sheet having a first series of parallel evenly spaced slots;
providing a second sheet of material for a battery cathode, the second sheet having a second series of parallel evenly spaced slots matching the first series of slots;
placing a separator sheet between the first sheet and the second sheet to form a laminate, the slots of the first sheet aligned with the slots of the second sheet; and
folding the laminate along multiple parallel folds, each fold aligned with a corresponding slot;
wherein alternating folds are folded in opposite directions to form a concertina configuration.

2. The method of claim 1, wherein each fold is a fold of approximately 180 degrees.

3. The method of claim 1, wherein the first sheet of material contains lithium ions.

4. The method of claim 1, wherein the material between each pair of adjacent slots is considered a finger; and the method further comprises applying pressure from opposing sides of the concertina configuration to maintain contact between each finger and the separator sheet:

5. The method of claim 1, wherein the slots extend to one edge of the first sheet but not to an opposing edge of the first sheet.

6. The method of claim 1, wherein the slots do not extend to any edge of the first sheet.

7. The method of claim 1, further comprising placing the concertina configuration in a battery case.

8. A computer-readable non-transitory storage medium that contains instructions, which when executed by one or more processors result in performing operations comprising:
providing a first sheet of material for a battery anode, the first sheet having a first series of parallel evenly spaced slots;
providing a second sheet of material for a battery cathode, the second sheet having a second series of parallel evenly spaced slots matching the first series of slots;
placing a separator sheet between the first sheet and the second sheet to form a laminate, the slots of the first sheet aligned with the slots of the second sheet; and
folding the laminate along multiple parallel folds, each fold aligned with a corresponding slot;
wherein alternating folds are folded in opposite directions to form a concertina configuration.

9. The medium of claim 8, wherein each fold is a fold of approximately 180 degrees.

10. The medium of claim 8, wherein the first sheet of material contains lithium ions.

11. The medium of claim 8, wherein the material between each pair of adjacent slots is considered a finger; and the method further comprises applying pressure from opposing sides of the concertina configuration to maintain contact between each finger and the separator sheet:

12. The medium of claim 8, wherein the slots extend to one edge of the first sheet but not to an opposing edge of the first sheet.

13. The medium of claim 8, wherein the slots do not extend to any edge of the first sheet.

14. The medium of claim 8, wherein the operations further comprise placing the concertina configuration in a battery case.

15. A battery assembly, comprising:
a laminate having an anode sheet with parallel evenly spaced slots, a cathode sheet with parallel evenly spaced slots, and an unslotted separator sheet between the anode sheet and the cathode sheet;
wherein the laminate is folded into a concertina configuration with 180 degree folds aligned with the slots.

16. The battery assembly of claim 15, wherein the anode sheet contains lithium ions.

17. The battery assembly of claim 15, wherein the slots of the anode sheet and the slots of the cathode sheet are open at a same end of the laminate.

18. The battery assembly of claim 15, wherein the slots of the anode sheet and the slots of the cathode sheet are open at opposite edges of the laminate.

19. The battery assembly of claim 15, wherein the slots of the anode are not open at any edge of the anode sheet.

20. The battery assembly of claim 15, further comprising a battery case containing the concertina configuration.
